(19) United States
(12) Patent Application Publication
(10) Pub. No.: US 2025/0278251 A1
(43) Pub. Date: Sep. 4, 2025

(54) CODE GENERATION PLATFORM WITH APPLICATION SECURITY TESTING

(71) Applicants: Shannon James SMITH, Woodinville, WA (US); Jimmy Lee ALDERSON, Las Vegas, NV (US)

(72) Inventors: Shannon James SMITH, Woodinville, WA (US); Jimmy Lee ALDERSON, Las Vegas, NV (US)

(21) Appl. No.: 19/068,956

(22) Filed: Mar. 3, 2025

Related U.S. Application Data
(60) Provisional application No. 63/561,135, filed on Mar. 4, 2024.

(51) Int. Cl. G06F 8/30; G06F 11/3668

(52) U.S. Cl. CPC G06F 8/30; G06F 11/3668

(57) ABSTRACT

Security testing features and capabilities are included in a code generation platform (CodeValet) that utilizes a robust set of security capabilities across the application lifecycle to ensure the reliability and integrity of the generated code. Some key benefits and advantages of CodeValet's automated code generation and security testing for developers and businesses include considerable time savings on manual coding, allowing developers to focus on architecture rather than implementation. Rapid prototyping and experimentation are enabled through quick proof-of-concept code generation. Developer fatigue and burnout are reduced by automating mundane tasks. Capabilities and productivity are augmented, allowing developers to accomplish more. On-demand code generation provides support for converting requirements when needed. A safety net of code quality checks reduces human errors.

### CROSS REFERENCE

This application claims priority to U.S. Provisional Application No. 63/561,135, titled “AI-BASED CODE GENERATION PLATFORM WITH APPLICATION SECURITY TESTING,” filed on Mar. 4, 2024.

### TECHNICAL FIELD

The present disclosure relates generally to software, including artificial intelligence and machine learning, technologies. More specifically, the present disclosure relates to systems and methods for automatic software code generation.

### BACKGROUND

The subject matter disclosed herein relates to the subject matter of Internation Patent Application PCT/IB2024/060152, filed Nov. 7, 2024, titled “SYSTEMS AND METHODS FOR AUTOMATED SOFTWARE CODE GENERATION”. This application is commonly assigned to the assignee of the present application, CodeValet, Inc., and is hereby incorporated by reference in its entirety.

The CodeValet Internation Patent Application describes a system that uses artificial intelligence (AI) and other algorithmic techniques to automatically generate software code based on natural language prompts. As described in greater detail in the application, the CodeValet platform employs neural network models trained on large datasets of existing source code. This allows the AI models to learn common programming patterns and constructs. By analyzing a natural language description of desired code provided by the user, CodeValet can generate corresponding code that matches the intent behind the description.

The CodeValet platform includes certain automated testing pipelines. These include, among others, Static Analysis. With Static Analysis, code is analyzed without execution to detect quality issues, security vulnerabilities, etc. With Static Analysis and other testing pipelines, the testing results are provided as feedback to improve CodeValet's AI models and code generation skills over time. This incremental learning approach enhances quality.

CodeValet, in summary, combines codebase-specific AI model tuning, automated testing pipelines, modular implementation and continuous self-improvement to generate highly accurate and reliable code from natural language. It can integrate into existing developer workflows rather than fully automate them, allowing proper validation of generated code. An exemplary result of the CodeValet platform is to amplify programmer productivity and enable rapid prototyping while maintaining robustness.

### SUMMARY

The present disclosure describes a system and method for generating secure software code using artificial intelligence. The system comprises a code generation module that generates source code based on natural language inputs, a security testing module that performs various security tests on the generated code, a results analysis module that evaluates the test results to identify vulnerabilities, and a mitigation module that automatically applies fixes to the code. The system also includes a novel feature where the mitigation module formulates targeted security requirements based on identified vulnerabilities and feeds these requirements back into the code generation module to regenerate sections of flawed code in a secure manner. This approach enables the system to not only identify and fix vulnerabilities but also to learn from these vulnerabilities and improve the security of future code generation. The system thus provides a comprehensive solution for generating, testing, and securing software code, potentially revolutionizing the field of secure software development.

Additional techniques like fuzzing and penetration testing probe running applications to uncover flaws static analysis may miss. Cloud infrastructure is codified and monitored to enforce secure operational deployment. Traffic is restricted, and least privilege access maintained. Security is shifted left through continuous validation from design through runtime. Testing results also provide feedback to improve CodeValet's AI models and reduce risks. Multiple techniques compose a defense-in-depth against general weaknesses and application-specific threats.

By thoroughly analyzing and hardening AI-generated code, CodeValet prevents introduction of new vulnerabilities while catching inherited risks. Integration of innovative testing, automated mitigations, and self-protection makes CodeValet uniquely capable of delivering highly secure code.

Some key benefits and advantages of CodeValet's AI-driven automated code generation and security testing for developers and businesses include significant time savings on manual coding, allowing developers to focus on architecture rather than implementation. Rapid prototyping and experimentation are enabled through quick proof-of-concept code generation. Developer fatigue and burnout are reduced by automating mundane tasks. Capabilities and productivity are augmented, allowing developers to accomplish more. On-demand code generation provides support for converting requirements when needed. A safety net of code quality checks reduces human errors.

For businesses, CodeValet accelerates development cycles, speeds innovation, and allows faster time-to-market. Innovation capacity is increased despite limited developer resources. Consistency and reliability of code improves quality and reduces technical debt. Automated security analysis and hardening boosts security. Bottlenecks from fatigue and lack of capacity are eliminated. Productivity gains level the playing field against competitors. Savings on manual programming and QA costs are achieved.

By leveraging AI to automate coding while still delivering robust and secure code, CodeValet provides transformative benefits for developers and organizations seeking to amplify productivity, quality, speed, and innovation potential. The technology represents a fundamental step forward for software engineering.

### BRIEF DESCRIPTION OF THE DRAWINGS

FIG. 1 is a simplified architecture diagram showing security components deployed with the code generation pipeline.

FIG. 1A is a more detailed architecture diagram showing how the security components may be connected with the code generation module.

FIG. 2 is a flowchart of an illustrative static analysis process.

FIG. 3 is a flowchart of an illustrative dynamic analysis process.

FIG. 4 is a diagram for an illustrative software composition analysis process.

FIG. 5 is a data flow diagram for an illustrative process for prioritization by exploit likelihood.

FIG. 6 is a cloud infrastructure diagram showing security controls.

FIG. 7 is a high-level test architecture diagram.

FIG. 8 is an activity diagram of an illustrative application hardening process. This diagram depicts steps involved in analyzing code risks, applying mitigations, and reducing attack surface.

### DETAILED DESCRIPTION OF ILLUSTRATIVE EMBODIMENTS

### Overview

The present disclosure will focus on ways to integrate a robust security testing process into the CodeValet code generation system. We first provide an overview of Application Security Testing and Secure Application Deployment before discussing each of the various security measures individually.

### 1. Application Security Testing

### 1.1. SAST—Static Application Security Testing

CodeValet performs static analysis on generated source code to identify vulnerabilities without executing the application. Customized rules encoded based on vulnerabilities like SQL injection, XSS, etc. are checked against the code. Violations are flagged and mitigated by applying secure coding best practices.

Advanced static analysis reviews the code for weaknesses like SQL injection, XSS, data exposure, broken access control, etc. Analysis occurs at code and bytecode levels. Coding standards violations are accurately flagged. Vulnerabilities are automatically mitigated via input validation, proper encryption, and role-based access control. Static analysis and auto-remediation reduce vulnerabilities without manual effort.

### 1.2. IAST—Interactive Application Security Testing

As generated code runs during testing, CodeValet employs interactive analysis for deeper insights. Relevant execution events like inputs, API calls, queries, etc. are monitored and analyzed to detect vulnerabilities missed by static scanning. For example, inputs are checked against threat feeds, and data flows tracked to uncover leakage issues. Findings map back to source code to guide remediation. Interactive analysis complements static scanning with runtime validation.

### 1.3. DAST—Dynamic Application Security Testing

CodeValet leverages DAST capabilities to find weaknesses static analysis misses. DAST tools crawl the attack surface, manipulating inputs to expose flaws not evident from source code. Intelligent fuzzing feeds expected and unexpected values into forms to trigger exceptions indicating potential risks. Custom payloads simulate attacks. Issues discovered map back to code locations to drive fixes. Automated penetration testing is conducted to emulate attacks without production impact. DAST insights complement static scanning for comprehensive validation.

### 1.4. SCA—Software Composition Analysis

CodeValet performs extensive SCA on integrated open source libraries and components, identifying known vulnerabilities, outdated versions, licensing issues, and related risks. A Software Bill of Materials (SBOM) provides a complete inventory of the generated code's software supply chain. Discovered vulnerabilities are automatically prioritized for patching based on criticality ratings and threat intelligence regarding real-world exploits. CodeValet recommends upgrades or alternate dependencies to eliminate vulnerable components. The SBOM enables full visibility into composition risks, and automation simplifies remediation.

### 1.4.1. SBOM—Software Bill of Materials

The SBOM provides a complete list of third-party open source dependencies integrated into the generated codebase, including component, version, and license information. CodeValet produces the SBOM to enable software composition analysis.

### 1.4.2. VEX—Vulnerability Exploitability Exchange

CodeValet cross-correlates details about uncovered vulnerabilities with available exploit data and threat models to empirically estimate the real-world likelihood of successful exploitation. This allows intelligent prioritization of patching based on actual risk rather than just CVSS scores. Accurate automated risk analysis is enabled without security expertise.

### 2. Secure Application Deployment

### 2.1Application Hardening

CodeValet analyzes generated code to identify and remove unnecessary functions, ports, services, etc. to reduce accessible vulnerabilities. Checks are added to verify user identities and enforce access control across available interfaces. Cryptography protects sensitive data processed and stored. Input sanitization, filtering and validation blocks injection attacks. Attack surface reduction and proactive hardening are applied automatically based on CodeValet's full understanding of application structure and flows.

### 2.2. CSPM/ASPM—Secure Cloud Application Configuration

For cloud deployment, CodeValet codifies and configures infrastructure-as-code, enforcing compliance to prevent drift. Network controls restrict traffic between resources. Encryption protects data leakage. Least privilege access limits damage from compromised credentials. Changes are tracked for auditability. Deep security integration into the DevOps pipeline produces secure cloud application configuration.

### 2.3. WAF—Web Application Firewall Configuration

CodeValet implements a WAF to monitor and control application traffic. Detected attacks are blocked while valid traffic passes through. Rules tailor protection based on architecture, frameworks, and vulnerabilities. CodeValet optimizes WAF configuration leveraging its comprehensive application knowledge, maximizing protection without impacting legitimate use.

### 2.4. RASP—Runtime Application Self-Protection

Lightweight RASP agents monitor the running application to detect and respond to threats by terminating malicious processes. Integration with monitoring systems enables rapid response. CodeValet optimizes RASP to provide targeted protection without performance impact, based on its deep runtime awareness. The application is continuously evaluated across its lifecycle using these techniques to shift security left and ensure code produced by CodeValet remains resilient against threats while avoiding introducing new risks.

### Architecture

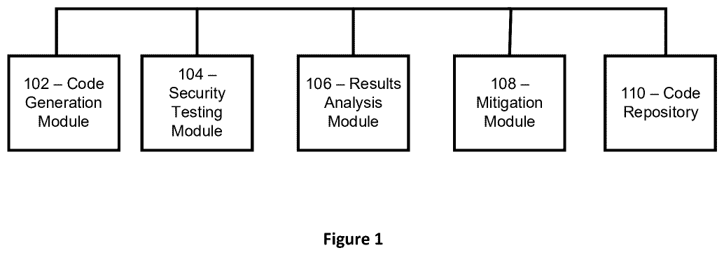

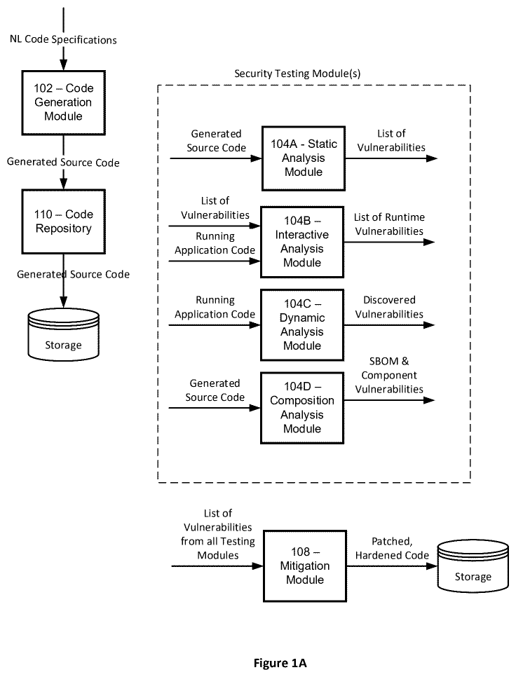

FIG. 1 is an architecture diagram showing security components integrated into the code generation pipeline. This provides an overview of how security scanning, analysis, and testing modules fit into the end-to-end code generation workflow. The Code Generation Module (102) generates source code based on natural language inputs. It contains the trained neural network model that translates text to code. Alternative structures that could perform code generation include rule-based generation systems and template-based generators. The Security Testing Module (104) performs various security tests on the generated code. It contains components like static analysis tools, fuzz testing tools, penetration testing tools etc. Alternative ways to perform security testing include manual code reviews. The Results Analysis Module (106) evaluates the results from security testing to identify vulnerabilities and other issues in the generated code. It also provides feedback to improve the Code Generation Module (102). Alternative ways to analyze results include manual result review by experts. The Mitigation Module (108) automatically applies fixes and improvements to the generated code based on insights from the Results Analysis Module (106). Other structures that could perform automated mitigation include expert systems and fixed scripts. The Code Repository (110) provides storage for the improved code that has passed testing and mitigation. It interfaces with developer tools like version control systems. Alternatives for code storage include file servers and databases.

As illustrated in FIG. 1A, the CodeValet system utilizes an integrated pipeline connecting code generation and application security testing capabilities. This exemplary implementation demonstrates how CodeValet leverages various analysis techniques across the software life cycle to shift security left.

The pipeline begins with the Code Generation Module (102), which takes natural language specifications as input and produces source code as output using the trained neural network models. Alternative techniques that could perform code generation include rule-based expert systems, traditional CAD tools, and hard-coded templates.

The generated source code then feeds into the Static Analysis Module (104A), which scans the code for vulnerabilities without execution. This white-box testing identifies issues like SQL injection or buffer overflows by checking against a library of encoded rules. Alternative techniques include manual code audits and heuristic-based scanning tools. Violations are output for mitigation.

Next, the Interactive Analysis Module (104B) monitors the running application, analyzing elements like data flows and inputs. Gray-box dynamic analysis picks up weaknesses like information leakage missed in static analysis. Alternative runtime techniques involve instrumentation-based behavioral monitoring and machine learning-powered anomaly detection. Findings are mapped back to code locations.

In parallel, the Dynamic Analysis Module (104C) fully black box tests the application to reveal flaws not evident statically. Fuzzing and attack simulations exercise different execution paths. Alternative dynamic methods include manual penetration testing and crowd-sourced security assessments. Issues are linked to responsible code.

The Composition Analysis Module (104D) inventories third-party libraries and dependencies integrated into the software supply chain. An SBOM documents all components for tracking vulnerabilities, licensing, and upgrade guidance. Alternatives include manual tracking, package management manifests, and open source audits.

Identified vulnerabilities flow into the Mitigation Module (108), which takes vulnerabilities and weaknesses identified by the various testing modules as input. It then automatically applies fixes and enhancements directly to the generated source code. The module contains logic to analyze the type of vulnerability and determine the optimal mitigation technique. For simpler issues like missing input validation, it can directly edit the code to add proper sanitization, filtering, escaping etc. For more complex bugs like logic errors, it utilizes the Code Generation Module (102) to regenerate sections of flawed code according to new secure coding requirements. The Code Generation Module leverages its deep understanding of the application and expertise in translating specifications into code. The Mitigation Module formulates targeted security requirements then feeds them back into code generation to rewrite vulnerable sections in a secure manner. For example, if dynamic testing uncovers a block of code vulnerable to SQL injection, the Mitigation Module will instruct the Code Generation Module to rewrite that database interaction logic incorporating proper input validation and parameterized queries. The regenerated code then flows back into the testing pipeline for validation. If issues persist, the Mitigation Module continues working in tandem with the Code Generation Module in an iterative process until all vulnerabilities are resolved. This close integration between automated mitigation and AI-driven coding allows CodeValet to rapidly harden the codebase against new threats. The system can incorporate security knowledge directly into the DNA of the software through code regeneration rather than just superficial patching. By utilizing code generation capabilities for mitigation, CodeValet can fundamentally enhance the secure development life cycle.

Here is an example of how the Mitigation Module works together with the Code Generation Module: Suppose dynamic analysis testing uncovers an authorization vulnerability in a section of code that controls user access to a set of restricted APIs. Specifically, the code fails to check if a user is an administrator before allowing access to administrator-level APIs. When this vulnerability is passed to the Mitigation Module, it first analyzes the problem and determines that proper access control checks need to be added to secure the code. The Mitigation Module formulates a new natural language specification such as: “Add authentication checks before restricted API access points. Verify user is in the ‘admin’ role before allowing access to admin-only APIs.” This specification is input into the Code Generation Module, which leverages its deep learning models to translate the instructions into corresponding source code. It generates new logic to check a user's role and throw authorization exceptions if the user does not have admin access. The newly generated authorization code segment replaces the vulnerable section and is integrated back into the full codebase. This is validated by rerunning dynamic analysis testing on the application. The inventive system has now automatically applied proper access control fixing the vulnerability. If issues persist, the Mitigation Module continuously works with the Code Generation Module to refine the specification and rewrite code until the application is hardened.

This demonstrates how the Mitigation Module's tight coupling with AI-powered coding allows for rapid and automated vulnerability remediation resulting in secure software.

This methodology combines multiple application security techniques to provide defense-in-depth critique of CodeValet's AI-generated software. The workflow maximizes early vulnerability discovery while minimizing false positives. Alternative implementations may utilize different toolsets, APIs, metrics, and integration patterns without departing from the core concepts of tightly coupling code creation and security analysis.

As mentioned, the CodeValet platform as described herein shifts security left. This refers to the practice of integrating security checks and testing earlier into the software development life cycle, rather than leaving it to later stages. CodeValet accomplishes this shift in several ways:
Static analysis scans source code for vulnerabilities as soon as it is generated, enabling remediation before functionality testing even begins. Finding issues earlier avoids accumulating technical debt.
Interactive analysis allows CodeValet to test and harden code as it is executed during development, not just right before release. Runtime data flows reveal weaknesses traditional static testing would miss.
Dynamic analysis thoroughly probes the attack surface early in the life cycle using techniques like fuzzing. Finding zero-day flaws sooner reduces cost.
Composition analysis bakes in software supply chain hygiene practices starting from initial integration of third-party libraries and components.
The iterative loops of testing, results analysis, and mitigation shifts the identification and resolution of vulnerabilities to the left of the life cycle.
Automated mitigation and patching shorten remediation timelines that otherwise delay releases and increase risk exposure.
Feedback loops rapidly incorporate learnings back into code generation, preventing recurrence of issues in future software versions.

Overall, CodeValet reinforces secure development practices at every stage, from design through development, testing, and deployment. Security is treated as a core functional requirement rather than an afterthought. By shifting left, CodeValet aims to release stable and secure code right from the initial iterations.

Integrating Security into CodeValet

The security validation capabilities could be built into CodeValet's pipelines. Static scanning runs first, followed by composition analysis on dependencies. Interactive scanning begins once the application can run. Dynamic scanning increases in intensity towards release. Security instrumentation is injected into the codebase for production monitoring. Testing results are aggregated in dashboards to track metrics over releases. Failed tests trigger tickets to drive remediation. Feedback loops enhance code generation by incorporating security knowledge into the AI models. Organizational policies determine compliance requirements. Secure code examples continuously improve the training data. The layered security approach delivers robust protection for AI-generated code.

### SAST—Static Application Security Testing

CodeValet performs static analysis on the generated source code to identify security vulnerabilities without executing the program. Customized rules encoded based on common vulnerabilities such as SQL injection, cross-site scripting, insecure data exposure, etc. are checked against the code. Violations are flagged and mitigated by automatically applying secure coding best practices to the generated code.

CodeValet utilizes advanced static analysis capabilities to review the generated source code for security vulnerabilities without needing to execute the application. Custom rules encoded based on OWASP Top 10 and other common weaknesses like SQL injection, cross-site scripting, insecure data exposure, broken access control etc. are checked against the code. Static analysis is performed at the code level as well as against compiled bytecode for languages like Java and .NET. Violations of secure coding standards are accurately flagged. The vulnerabilities are automatically mitigated by applying secure coding best practices directly to the generated code. For example, user inputs are sanitized, authenticated and authorized before use to prevent injection attacks. Proper encryption is implemented for handling sensitive data. Role-based access control enforced. CodeValet's static analysis and auto-remediation reduce vulnerabilities without needing to involve the developer.

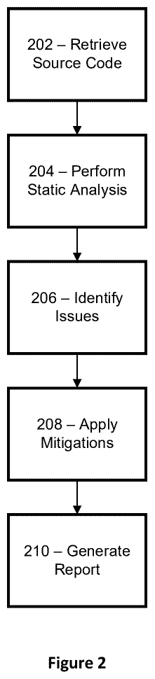

FIG. 2 is a flowchart of an illustrative static analysis process. This visualizes the steps involved in static scanning of source code for vulnerabilities-scanning, rule checks, reporting, mitigation application. The Retrieve Source Code step (202) obtains the generated source code that needs to be security tested. Alternatives for obtaining code include importing it from source code repositories. The Perform Static Analysis step (204) scans the code using static analysis tools to detect vulnerabilities without executing the code. An alternative way to perform static analysis is manual code review. The Identify Issues step (206) checks the static analysis results and extracts any identified vulnerabilities or violations of secure coding standards. Alternative techniques for identifying issues involve machine learning models. The Apply Mitigations step (208) modifies the source code to fix the discovered vulnerabilities using methods like input validation, sanitization, encryption etc. An alternative is to manually mitigate issues. The Generate Report step (210) documents the findings from static analysis and the details of mitigations applied. The reports help improve the Code Generation Module (102). Alternatives to static analysis reporting include storing results in databases.

In practice, CodeValet's static analysis capabilities could leverage commercial or open-source SAST tools like Veracode, Checkmarx, SonarQube, or SpotBugs. Custom security rules tailored to common vulnerabilities in the programming languages used can be encoded. Static analysis can run incrementally as code is generated to provide rapid feedback. Violations could trigger automated mitigations like input sanitization and encryption applied to the code. Policies determine security standards compliance. Integration with IDEs gives developers instant scanning feedback. Results are tracked to report metrics like vulnerability density over time.

### IAST—Interactive Application Security Testing

As the generated application code is run during dynamic testing, CodeValet employs interactive analysis for deeper insights. Relevant execution events like user inputs, API calls, database queries etc. are monitored and analyzed to detect vulnerabilities missed by static scanning. For example, user inputs are analyzed at runtime for malicious patterns based on the latest threat intelligence feeds. Safe data handling is verified across the entire workflow. Code instrumentation inserted by CodeValet helps accurately track data flow across methods to uncover issues like information leakage. Any findings are mapped back to the specific lines of source code responsible to guide remediation. Interactive analysis provides runtime validation to complement static scanning.

As the generated code is run, relevant execution events and data flows are monitored to detect vulnerabilities missed by static analysis. For example, user input analyzed at runtime for malicious patterns based on threat intelligence feeds. Code instrumentation helps track data flow across methods to uncover issues like information leakage. Findings are mapped back to the source code for fixing.

For interactive analysis, CodeValet could integrate commercial solutions like Contrast Security, AppSec Engine, or Sqreen to monitor runtime application activity. Agents added to the code collect data flows, API calls, user inputs etc. Cloud infrastructure APIs provide additional context. Suspicious inputs are checked against threat intel feeds and suspicious activity triggers alerts. Data flow maps visualize relationships between sources and sinks. Findings are linked back to code locations by correlating runtime events to instrumentation points. IAST provides validation of secure coding practices implemented based on static scan results.

### SCA—Software Composition Analysis

All third-party open source dependencies integrated into the generated code are scanned to identify vulnerabilities, outdated versions, and licensing issues. An inventory of all software components is created in the form of an SBOM (Software Bill of Materials). Vulnerabilities are automatically prioritized based on criticality and patches/upgrades recommended.

CodeValet performs extensive software composition analysis on all third-party open source libraries and components integrated into the generated codebase. Known vulnerabilities, outdated versions, improper licensing and related risks in OSS dependencies are identified via SCA. A complete inventory of the software supply chain is constructed in the form of a Software Bill of Materials (SBOM). Discovered vulnerabilities are automatically prioritized for patching based on criticality ratings from sources like NVD as well as threat intelligence on active real-world exploits. CodeValet recommends upgrades or alternative libraries to eliminate vulnerable components. The SBOM provides full visibility into the composition risks, and automation simplifies remediation.

CodeValet could leverage SCA tools like Synopsys Black Duck, Sonatype Nexus, or WhiteSource to detect open source component risks. The generated dependency graph is continuously analyzed against NVD and other databases to find vulnerabilities. Integrations with build tools automatically scan packages pre-integration. License compliance issues are flagged. Policies determine actions like blocking outdated libraries or denying unapproved licenses. An SBOM inventory provides a comprehensive view of the software supply chain security posture. Automated upgrades and patches remediate risks based on policy thresholds.

### VEX—Vulnerability Exploitability Exchange

By correlating details about an uncovered vulnerability with available exploit data and threat models, the likelihood of the vulnerability being successfully exploited is assessed. This allows intelligent patching prioritization based on real exploit risk rather than just CVSS scores.

For vulnerabilities uncovered in the codebase, CodeValet cross-correlates details about the specific weakness with available exploit data and existing threat models to derive an empirical estimate of the real-world likelihood of the vulnerability being successfully exploited. This allows intelligent prioritization of patching based on actual exploit risk rather than just static CVSS scores. The rich vulnerability intelligence data from CodeValet's VEX program enables accurate risk analysis without needing security expertise. Proactive patching where exploit risk is high can be balanced with managing less critical weaknesses.

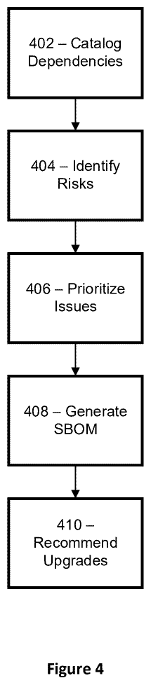

FIG. 4 is a diagram for an illustrative software composition analysis process. This shows the sequence of inventorying dependencies, identifying risks, generating SBOM, and recommending upgrades.

The Catalog Dependencies step (402) inventories all third-party open source libraries and components integrated into the generated codebase. An alternative way to catalog dependencies is through manual bibliographies. The Identify Risks step (404) checks catalogued dependencies against vulnerability databases to identify any outdated, vulnerable or unlicensed components. Commercial composition analysis tools provide an alternative way to identify risks. The Prioritize Issues step (406) assigns risk ratings and rankings to discovered vulnerabilities based on severity, likeliness of exploitation etc. An alternative is to rely on the ratings assigned by vendors. The Generate SBOM step (408) consolidates the inventory of dependencies and associated risks into a Software Bill of Materials document. Alternatives formats for an SBOM include spreadsheets. The Recommend Upgrades step (410) provides suggested patches, newer versions, or alternative dependencies to address identified risks. An alternative is to simply notify development teams of risks.

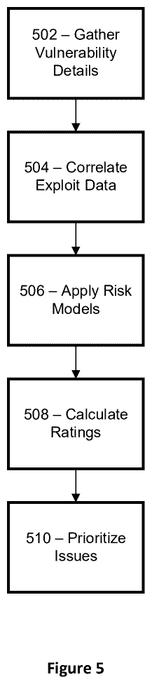

FIG. 5 is a data flow diagram for an illustrative process for prioritization by exploit likelihood. This illustrates how vulnerability data, threat intel and risk models are correlated to derive realistic exploit probabilities.

The Gather Vulnerability Details step (502) collects technical information about discovered vulnerabilities like impacted versions, attack vectors, privileges required etc. Integrated issue trackers provide an alternative way to gather vulnerability details. The Correlate Exploit Data step (504) matches vulnerability details against known exploit code, proof-of-concepts, and active threats. Commercial threat intelligence feeds are an alternative source of exploit data. The Apply Risk Models step (506) runs mathematical models using the vulnerability details and exploit potential to estimate likelihood of successful attacks in the real world. A qualitative risk analysis is an alternative to models. The Calculate Ratings step (508) converts the risk likelihoods into numerical ratings that quantify the probability and business impact of exploitation. Manual risk rating processes provide an alternative way to calculate ratings. The Prioritize Issues step (510) assigns remediation priorities to vulnerabilities based on ratings. More serious exploit risks are prioritized higher. An alternative is to rely solely on severity scores like CVSS for prioritization.

The VEX module could leverage threat intel feeds with exploit details from companies like Recorded Future, RiskIQ, and IntSights. Natural language processing extracts technical vulnerability data like vectors and payloads. Correlation algorithms match this against known exploit code and active attacks. Risk models take this intelligence and calculate probabilistic exploit likelihood ratings for each vulnerability. These ratings feed into the orchestration and prioritization logic to focus remediation on actual threats rather than just potential issues.

### DAST—Dynamic Application Security Testing

CodeValet performs dynamic application security testing on the running application to detect vulnerabilities that static analysis may miss. DAST tools crawl the application flows while manipulating inputs to expose security flaws not evident from source code. For example, fuzz testing inserts random boundary values into forms to trigger exceptions. Custom attack payloads based on OWASP test cases are used to probe for weaknesses. Identified vulnerabilities are mapped back to the responsible code locations to guide remediation efforts. Automated penetration testing is conducted to simulate real attacks without impacting production systems. The insights from dynamic testing complement static analysis findings for comprehensive security validation.

CodeValet leverages dynamic application security testing capabilities to detect flaws and weaknesses in the running application that static analysis of source code cannot uncover. Advanced DAST tools crawl the application attack surface to find vulnerabilities that emerge only at runtime. For example, fuzz testing automatically inserts random boundary values into application forms and inputs to trigger exceptions that may point to injection risks. Custom attack payloads are generated based on OWASP test cases and fed into the application to probe for security gaps. Discovered issues are mapped back to the specific code locations to guide remediation. Risk-based automated penetration testing is conducted to simulate real attacks without impacting production systems. The insights from DAST complement static scanning for comprehensive security validation.

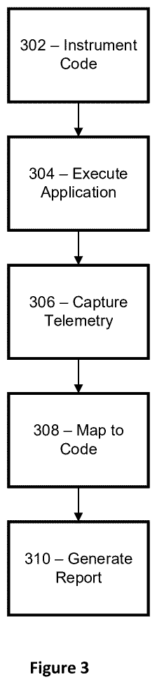

FIG. 3 is a flowchart of an illustrative dynamic analysis process. This depicts runtime monitoring, instrumentation, attack simulation, and mapping findings back to code.

The Instrument Code step (302) inserts monitors and tracking code into the application to observe runtime events and data flows. Alternative ways to instrument code involve binary instrumentation tools. The Execute Application step (304) runs the instrumented application and exercises its features to simulate production use. Alternative techniques to execute the application include synthetic workloads. The Capture Telemetry step (306) records the instrumentation data on flows, inputs, exceptions etc. as the application executes. External monitoring tools provide an alternative way to capture telemetry. The Map to Code step (308) correlates the recorded runtime telemetry to the related lines of source code. This enables pinpointing issues. An alternative is static mapping of instrumentation points. The Generate Report step (310) documents the runtime issues discovered through dynamic analysis. The findings complement static analysis results. Alternatives to reporting include visual dashboards.

CodeValet could integrate leading DAST testing tools like Burp Suite, ZAP, or OWASP Zed to dynamically probe the running application. The attack surface is automatically crawled while manipulating parameters and inputs to reveal vulnerabilities. Intelligent fuzzing feeds both expected and unexpected values into input forms. Custom payloads simulate attacks like SQLi. An authentication matrix tracks testing coverage of different user roles. Any security events trigger alerts. Regular, non-impacting penetration tests validate the efficacy of implemented controls.

### Secure Application Deployment

### CSPM/ASPM—Secure Cloud App Configuration

For cloud-based deployment, the application infrastructure is codified and instantiated as code using Infrastructure-as-Code tools. Security policies are enforced on the resulting environment configuration across levels-network, compute, storage, access control etc. Continuously monitors for and remediates configuration drift.

For applications deployed to cloud environments, CodeValet codifies and configures the supporting infrastructure-as-code. Continuous cloud security posture management enforces compliance with regulatory and organizational standards, preventing configuration drift. Network security groups restrict traffic between cloud resources. Encryption for data at rest and in transit provides leakage protection. Least privilege access implemented via role-based controls and just-in-time elevated credentials. Changes are tracked to enable auditability. Integration of security deep into the DevOps pipeline results in secure cloud configurations.

### WAF-Web Application Firewall

A web application firewall is implemented to monitor and control HTTP traffic to the application. Detected attacks such as SQLi, XSS, RFI etc. are blocked while valid traffic is passed through. Rules are tailored to the specific app being protected based on its architecture, frameworks and common vulnerabilities.

### RASP—Runtime Application Self-Protection

Lightweight agents embedded in the running application perform real-time monitoring to detect and respond to threats. For example, terminating processes exhibiting anomalous behaviors indicative of malware execution or memory manipulation attacks. Integrates with monitoring systems to enable rapid response.

### Application Hardening

Generated application code is analyzed for common weaknesses that can be proactively secured against attacks. Examples include disabling unused components, encrypting sensitive data, validating inputs, minimizing exposed attack surfaces etc. Hardening measures are automated applied to further reduce vulnerabilities.

The application is continuously evaluated across its lifecycle using the above techniques to shift security left and ensure the code produced by CodeValet is resilient against real-world threats while avoiding introducing new risks itself.

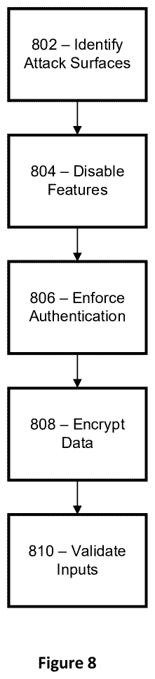

FIG. 8 is an activity diagram of an illustrative application hardening process. This diagram depicts steps involved in analyzing code risks, applying mitigations, and reducing attack surface.

The Identify Attack Surfaces step (802) analyzes the generated code to find exposed components and flows that present security risks. Attack surface mapping tools provide an alternative way to identify attack surfaces. The Disable Features step (804) disables any unnecessary functions, ports, services etc. to reduce accessible vulnerabilities. An alternative way to reduce attack surfaces is modifying configurations. The Enforce Authentication step (806) inserts checks to verify user identities and access authorizations across available application interfaces. Third-party authentication libraries provide an alternative way to enforce authentication. The Encrypt Data step (808) adds cryptographic protections for sensitive user data processed and stored by the application. External encryption gateways are an alternative method for encrypting data. The Validate Inputs step (810) inserts sanitization, filtering and validation of untrusted data entered into the application. This prevents injection attacks. Input verification APIs provide an alternative way to validate inputs.

### Cloud Infrastructure

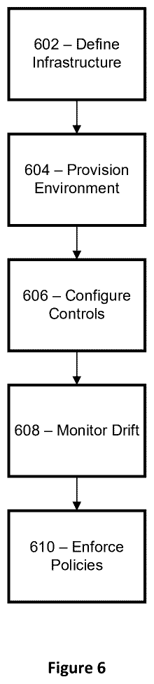

FIG. 6 is a cloud infrastructure diagram showing security controls. This depicts a secure network topology, access controls, encryption, and other aspects of hardened cloud deployment.

The Define Infrastructure step (602) codifies the cloud network topology, components, configurations etc. in machine-readable definition files. Graphical cloud design tools provide an alternative way to define the infrastructure. The Provision Environment step (604) instantiates the defined cloud infrastructure programmatically based on the definition files. The alternative is to manually set up the environment. The Configure Controls step (606) sets up security controls like encryption, access roles, network segmentation etc. across the provisioned environment. Third-party tools provide an alternative way to configure controls. The Monitor Drift step (608) continuously evaluates the running environment to detect deviations from the secure baseline. Manual periodic reviews are an alternative way to monitor for drift. The Enforce Policies step (610) automatically fixes any drift or violations of security policies detected through monitoring. An alternative is to generate alerts instead of automatically fixing issues.

### Test Architecture

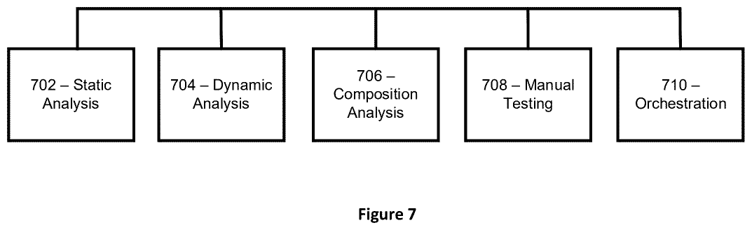

FIG. 7 is a high-level test architecture diagram. It provides an overview of security test types, tools, coverage, and integration with pipelines.

Static Analysis (702) represents static analysis tools and capabilities as part of the integrated security testing approach. Open source scanning tools are alternatives for static analysis. Dynamic Analysis (704) represents dynamic analysis tools and capabilities as part of the integrated security testing approach. Commercial DAST services provide an alternative for dynamic analysis. Composition Analysis (706) represents software composition analysis tools and capabilities as part of the integrated security testing approach. Alternatives for composition analysis include SBOM generation tools. Manual Testing (708) represents expert security testing and code review capabilities as part of the integrated testing approach. An alternative is fully automated testing with no manual component. Orchestration (710) represents test orchestration capabilities for managing, coordinating and automating the different testing tools and techniques. Custom test harnesses are an alternative approach for test orchestration.

### Handling Failed Tests

CodeValet's test execution framework automatically triggers a new iteration of code generation to address any specific functionality that fails unit or integration testing. The updated code is then retested to validate the issue is fixed. This cycle repeats until all tests pass.

For failed security tests like static analysis or DAST scans, CodeValet programmatically evaluates the findings to identify the optimal type of mitigation needed based on the vulnerability details. For simpler issues like missing input validation, CodeValet can directly edit the code to apply fixes such as sanitization and filtering. For more complex bugs like logic errors that require new code, CodeValet generates requirements updated to address the flawed logic and generates new code for impacted modules. Data flow analysis traces sources of vulnerabilities across function calls to pinpoint the origin so that new code can be generated.

Failed penetration tests and red teaming kick off a security-focused model retraining to improve code generation security awareness. If a particular vulnerability type recurs across projects, generic security enhancements are added to CodeValet's core model training process. For operational issues like performance bottlenecks, CodeValet can rewrite inefficient sections of code using updated requirements optimized for speed.

CodeValet tracks test failures to provide metrics on code quality over time and monitor regression across releases. Bug tickets are automatically opened with all details for developers to review and validate the remediation. For severe failures, CodeValet flags the generated code as needing human review before release. Integrations with version control avoid merging vulnerable code.

In summary, failed tests trigger an iterative process of targeted new code generation and security enhancements to rapidly address the specific flaws uncovered. CodeValet aims to remediate issues before they impact end users.

### CONCLUSION

The present disclosure describes a novel system for leveraging AI to automatically generate secure, robust software code. CodeValet integrates novel capabilities for code generation powered by deep learning, comprehensive security analysis spanning the development lifecycle, automated remediation, and continuous feedback loops for incremental improvement. By combining neural code generation with robust application security testing techniques, CodeValet aims to amplify programmer productivity while delivering reliable, high-quality code. Developers can focus more on design rather than implementation. Rapid prototyping is enabled via generated proof-of-concept code. Developer fatigue is reduced by automating mundane tasks. On-demand code generation augments capabilities. For businesses, CodeValet accelerates release cycles, boosts innovation capacity, and provides competitive advantage. Security is shifted left, eliminating bottlenecks while leveling the playing field. Savings on manual efforts further improve efficiency.

The integrated security testing regimen validates functionality, detects vulnerabilities, and hardens applications. Techniques like SAST, DAST, IAST, SCA, fuzzing, and penetration testing analyze from all angles. Cloud infrastructure is secured through posture management. Failed tests trigger targeted regenerations to rapidly remediate flaws. By thoroughly analyzing and hardening AI-generated code, CodeValet mitigates risks both inherited and introduced. The system represents a fundamental advancement in leveraging AI to automate programming while maintaining robustness. CodeValet delivers tangible benefits across the software development lifecycle.

It should be appreciated that variations and modifications may be made to the embodiments described herein without departing from the scope of the invention. Architecture, component configurations, security techniques, testing methods, and integration models can be adapted to particular environments without limiting the focus on AI-driven automated code generation with integrated security. The specific solutions presented aim to enable secure, reliable, and efficient software creation via artificial intelligence.

We claim:

1. A system for generating secure software code, comprising:
a code generation module (102) configured to generate source code based on natural language inputs;
a security testing module (104) configured to perform security tests on the generated source code;
a results analysis module (106) configured to evaluate results from the security testing to identify vulnerabilities in the generated source code;
a mitigation module (108) configured to automatically apply fixes to the generated source code based on insights from the results analysis module; and
a code repository (110) configured to store the improved code that has passed testing and mitigation;
wherein the mitigation module (108) is further configured to formulate targeted security requirements based on identified vulnerabilities and feed the security requirements back into the code generation module (102) to regenerate sections of flawed code in a secure manner.

2. The system of claim 1, wherein the security testing module (104) comprises a static analysis module (104A) configured to scan the generated source code for vulnerabilities without executing the code.

3. The system of claim 2, wherein the static analysis module (104A) is further configured to check the generated source code against customized rules encoded based on common vulnerabilities.

4. The system of claim 1, wherein the security testing module (104) comprises an interactive analysis module (104B) configured to monitor execution events of the generated source code during testing.

5. The system of claim 4, wherein the interactive analysis module (104B) is further configured to analyze user inputs at runtime for malicious patterns based on threat intelligence feeds.

6. The system of claim 1, wherein the security testing module (104) comprises a dynamic analysis module (104C) configured to perform fuzz testing on the generated source code.

7. The system of claim 1, wherein the security testing module (104) comprises a composition analysis module (104D) configured to perform software composition analysis on third-party dependencies integrated into the generated source code.

8. The system of claim 7, wherein the composition analysis module (104D) is further configured to generate a Software Bill of Materials (SBOM) for the generated source code.

9. The system of claim 8, further comprising a vulnerability exploitability exchange (VEX) module configured to assess the likelihood of vulnerabilities being successfully exploited based on real-world exploit data.

10. The system of claim 1, wherein the mitigation module (108) is further configured to automatically apply secure coding best practices to the generated source code.

11. A method for generating secure software code, comprising:
generating source code based on natural language inputs using a code generation module (102);
performing security tests on the generated source code using a security testing module (104);
evaluating results from the security testing to identify vulnerabilities in the generated source code using a results analysis module (106);
automatically applying fixes to the generated source code based on insights from the results analysis module using a mitigation module (108);
storing the improved code that has passed testing and mitigation in a code repository (110); and
formulating targeted security requirements based on identified vulnerabilities and feeding the security requirements back into the code generation module (102) to regenerate sections of flawed code in a secure manner.

12. The method of claim 11, wherein performing security tests comprises scanning the generated source code for vulnerabilities without executing the code using a static analysis module (104A).

13. The method of claim 12, further comprising checking the generated source code against customized rules encoded based on common vulnerabilities.

14. The method of claim 11, wherein performing security tests comprises monitoring execution events of the generated source code during testing using an interactive analysis module (104B).

15. The method of claim 14, further comprising analyzing user inputs at runtime for malicious patterns based on threat intelligence feeds.

16. The method of claim 11, wherein performing security tests comprises performing fuzz testing on the generated source code using a dynamic analysis module (104C).

17. The method of claim 11, wherein performing security tests comprises performing software composition analysis on third-party dependencies integrated into the generated source code using a composition analysis module (104D).

18. The method of claim 17, further comprising generating a Software Bill of Materials (SBOM) for the generated source code.

19. The method of claim 18, further comprising assessing the likelihood of vulnerabilities being successfully exploited based on real-world exploit data using a vulnerability exploitability exchange (VEX) module.

20. The method of claim 11, further comprising automatically applying secure coding best practices to the generated source code.

21. A non-transitory computer-readable medium storing instructions that, when executed by a processor, cause the processor to perform a method for generating secure software code, the method comprising:
generating source code based on natural language inputs using a code generation module (102);
performing security tests on the generated source code using a security testing module (104);
evaluating results from the security testing to identify vulnerabilities in the generated source code using a results analysis module (106);
automatically applying fixes to the generated source code based on insights from the results analysis module using a mitigation module (108);
storing the improved code that has passed testing and mitigation in a code repository (110); and
formulating targeted security requirements based on identified vulnerabilities and feeding the security requirements back into the code generation module (102) to regenerate sections of flawed code in a secure manner.

22. The non-transitory computer-readable medium of claim 21, wherein performing security tests comprises scanning the generated source code for vulnerabilities without executing the code using a static analysis module (104A).

23. The non-transitory computer-readable medium of claim 21, wherein performing security tests comprises monitoring execution events of the generated source code during testing using an interactive analysis module (104B).

24. The non-transitory computer-readable medium of claim 21, wherein performing security tests comprises performing fuzz testing on the generated source code using a dynamic analysis module (104C).

25. The non-transitory computer-readable medium of claim 21, wherein performing security tests comprises performing software composition analysis on third-party dependencies integrated into the generated source code using a composition analysis module (104D).

26. The non-transitory computer-readable medium of claim 25, wherein the method further comprises assessing the likelihood of vulnerabilities being successfully exploited based on real-world exploit data using a vulnerability exploitability exchange (VEX) module.

27. The non-transitory computer-readable medium of claim 21, wherein the method further comprises automatically applying secure coding best practices to the generated source code.
